(19) United States
(12) Patent Application Publication
(10) Pub. No.: US 2026/0268466 A1
(43) Pub. Date: Sep. 10, 2026

(54) ALTERNATING DIRECTION METHOD OF MULTIPLIERS WITH COMPOUND GAUSSIAN AND GENERATIVE ADVERSARIALNETWORK PRIORS

(71) Applicant: The Government of the United States of America, as represented by the Secretary of the Navy, Arlington, VA (US)

(72) Inventors: Carter Lyons, Washinton, DC (US); Raghu Raj, Washigton, DC (US); Margaret Cheney, Fort Collins, CO (US)

(73) Assignee: The Government of the United States of America, as represented by the Secretary of the Navy, Arlington, VA (US)

(21) Appl. No.: 19/548,363

(22) Filed: Feb. 24, 2026

Related U.S. Application Data
(60) Provisional application No. 63/762,258, filed on Feb. 24, 2025.

(51) Int. Cl. G06T 7/00; G01S 13/89

(52) U.S. Cl. CPC G06T 7/00; G01S 13/89; G06T 2207/10044; G06T 2207/20076; G06T 2207/20084

(57) ABSTRACT

Systems and methods are provided for image estimation that have advantages over conventional systems and methods. For example, embodiments of the present disclosure provide Alternating direction method of multipliers with Compound Gaussian and Generative Adversarial Network priors (A-CG-GAN), an image estimation process with a dual-structured learned and handcrafted prior that solves linear inverse problems with particular application in tomographic imaging and image compressive sensing. A-CG-GAN incorporates a dual-structured prior involving both a learned GAN component and a handcrafted CG component. By implementing the dual-structured prior, A-CG-GAN takes advantage of the benefits from both priors while reducing the limitations each prior imposes individually.

### CROSS REFERENCE TO RELATED APPLICATIONS

This application claims the benefit of U.S. Provisional Patent Application No. 63/762,258, filed on Feb. 24, 2025, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; nrltechtran@us.navy.mil, referencing Navy Case Number 212511-US2.

### FIELD OF THE DISCLOSURE

This disclosure relates to radars, including radar imaging.

### BACKGROUND

Radar imaging uses radio waves to produce high-resolution, 2D or 3D images of surfaces. Handcrafted approaches can iteratively minimize an objective function where regularization terms in the objection function are handcrafted to capture desired statistics of the inverse problem solution. A collective disadvantage of previous approaches, using handcrafted priors to solving linear inverse problems, is that they are limited to a relatively narrow set of signal priors (such as the Laplacian distribution for sparse signals). These priors are often unable to provide any useful regularity on the inverse problem solution when the forward operator of the inverse problem is a substantial undersampling. Further, data is not utilized in these approaches to provide a learned and informative regularization, which often better captures signal statistics than any single handcrafted prior.

Core Laplace methods include the Iterative Shrinkage and Thresholding Algorithm (ISTA), Compressive Sampling Matching Pursuit (CoSaMP), and l₁ least squares (l₁-LS). Each of these methods restricts the prior distribution of the desired inverse problem solution to the handcrafted Laplace distribution, which does not capture desired statistical properties including self-similarity, heavy-tailed marginal distributions, and self-reinforcement among local coefficients. High solution sparsity is critical to the success of Laplace prior methods, and high sparsity is not accurate for many real solutions of interest (e.g., images).

Core Student's t prior methods include Bayesian Compressive Sensing (BCS), which restricts prior distribution of the desired inverse problem solution to the Student's t distribution. Similarly to the Laplace distribution, the Student's t distribution does not capture desired statistical properties including self-similarity, heavy-tailed marginal distributions, and self-reinforcement among local coefficients. Furthermore, the Student's t distribution enforces high levels of solution sparsity, which is not accurate for many real solutions of interest (e.g., images).

Core Compound Gaussian (CG) prior methods include Hierarchical Bayesian Maximum a Posteriori (HBMAP), Compound Gaussian Least Squares (CG-LS), and Image Denoising using Scale Mixtures of Gaussians (ID-SMG). Each of these methods use a handcrafted CG prior in an iterative method that solves linear inverse problems. These methods outperform comparative iterative estimation approaches using Laplace and Student's t distributions, but HB-MAP and CG-LS are computationally intensive approaches taking significant time to solve the inverse problem while ID-SMG is only applicable to denoising inverse problems and not tomographic imaging or compressive sensing.

Learned Generative Adversarial Network (GAN) prior approaches, generally, provided higher quality solutions to linear inverse problems than handcrafted prior approaches by using data to train a GAN to sample from the distribution of desired solutions and then constraining the inverse problem solution to the range of the GAN. Collective disadvantages of GAN prior approaches include: a) GAN priors typically require a significant amount of data available to train with so that the GAN captures a superb representation of the inverse problem solution distribution; b) GAN priors are less flexible than handcrafted priors. That is, generalization to alternative datasets of inverse problem solutions inherently results in significant performance loss or requires the training of another GAN prior; c) Unlike handcrafted priors, performance of GAN prior approaches saturates with increasing sampling by the forward operator from the inverse problem; and d) Unlike handcrafted priors, theoretical guarantees of GAN prior approaches are elusive due to the non-convex GAN prior.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a block diagram of an image estimation system implementing an exemplary A-CG-GAN process in accordance with an embodiment of the present disclosure;

FIG. 1B is a block diagram showing exemplary components of an exemplary processor in accordance with an embodiment of the present disclosure;

FIG. 1C is a block diagram of an exemplary image estimation process that can be used by an image estimator in accordance with an embodiment of the present disclosure;

FIG. 2 is a diagram showing exemplary pseudocode for Image Estimation Process 1 in accordance with an embodiment of the present disclosure;

FIGS. 3A-3D are plots showing average Structural Similarity Index measure (SSIM) in accordance with an embodiment of the present disclosure;

FIGS. 4A and 4B are plots showing the average SSIM over the reconstructions of one hundred 64×64 images from A-CG-GAN and each of the four comparison methods in accordance with an embodiment of the present disclosure; and

FIG. 5 is a flowchart of an exemplary method in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide systems and methods for image estimation that have advantages over conventional systems and methods. For example, embodiments of the present disclosure provide Alternating direction method of multipliers with Compound Gaussian and Generative Adversarial Network priors (A-CG-GAN), an image estimation process with a dual-structured learned and handcrafted prior that solves linear inverse problems with particular application in tomographic imaging and image compressive sensing.

In an embodiment, A-CG-GAN is a method for inverse problems (e.g., image estimation) that incorporates a dual-structured prior involving both a learned GAN component and a handcrafted CG component. By implementing the dual-structured prior, A-CG-GAN takes advantage of the benefits from both priors while reducing the limitations each prior imposes individually. Specifically, A-CG-GAN has the same benefit of outperforming handcrafted prior approaches, in the quality of reconstructed inverse problem solutions, that other GAN prior approaches have while resolving many of the GAN prior approaches disadvantages including: a) even with minimal GAN training data (i.e., with a sub-optimal GAN), A-CG-GAN still provides relatively high-quality reconstructions; b) A-CG-GAN is able to generalized to alternative dataset distributions than the distribution used to train the GAN; c) the performance of A-CG-GAN does not saturate with less undersampling by the inverse problem forward operator; and d) theoretical guarantees on A-CG-GAN convergence have been derived. Further, the CG prior is a broad and powerful class of statistical priors that subsumes the Laplace prior and the Student's t distribution while better capturing statistical properties for many inverse problem solutions of interest.

### 2. Exemplary Image Estimation System

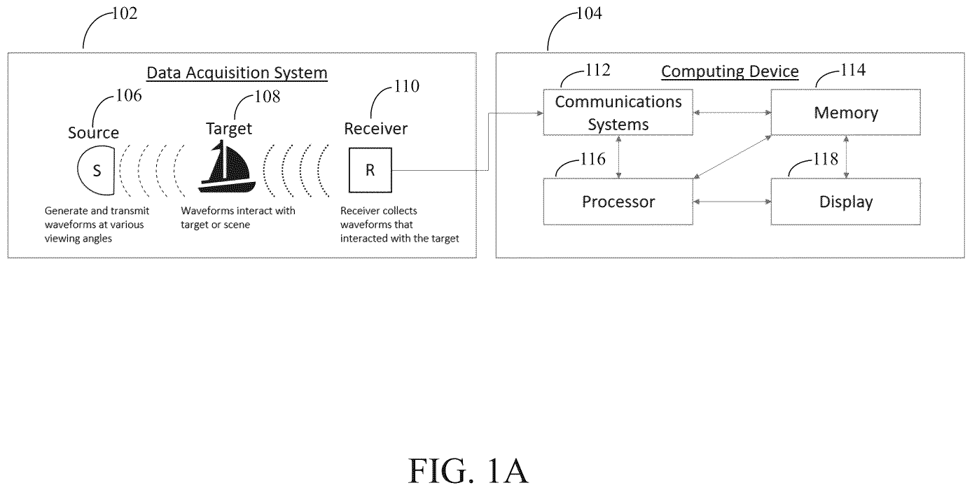

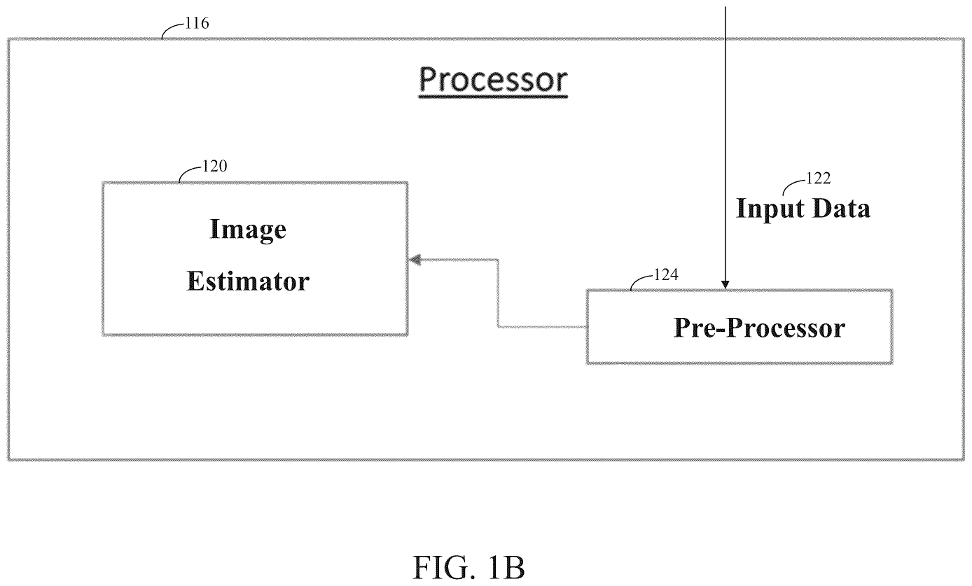

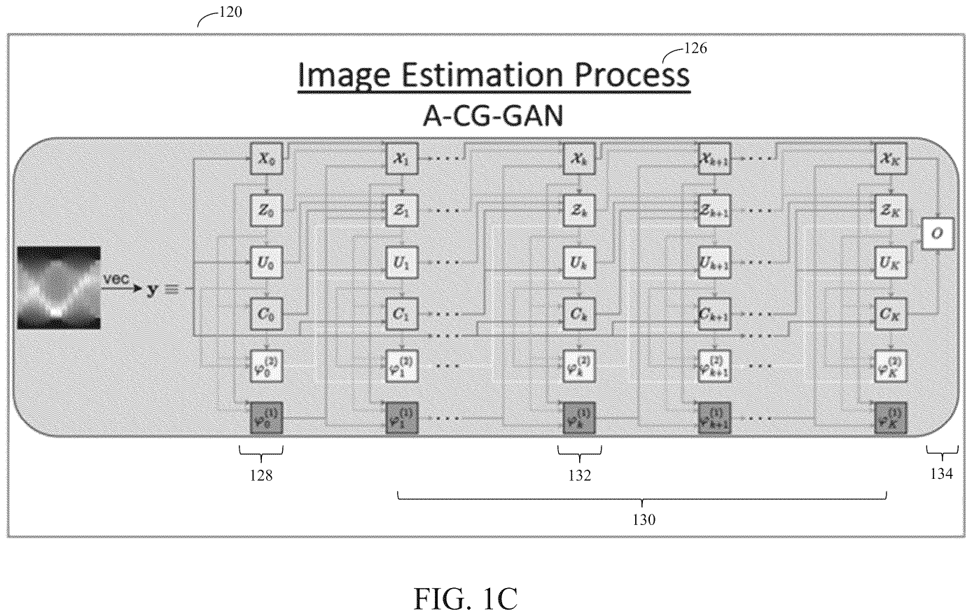

FIG. 1A is a block diagram of an image estimation system implementing an exemplary A-CG-GAN process in accordance with an embodiment of the present disclosure. The image estimation system of FIG. 1 includes a data acquisition system 102 and a computing device 104. In the data acquisition system 102, a source device 106 generates and transmits various waveforms at a target 108 or scene. These propagating waveforms interact with, and reflect off, the target 108 and are subsequently picked up by a receiver 110.

Next, in an embodiment, the receiver 110 transmits the raw signal data collected from the received waveforms to the computing device 104. In an embodiment, a communication subsystem 112 of the computing device 104 is used to send and receive signals to and from the computing device 104. In an embodiment, within the computing device 104, the communication subsystem 112 sends the raw signal data for storage in memory 114 and to a processor 116 as input, which can generate an output to a display 10.

FIG. 1B is a block diagram showing exemplary components of an exemplary processor in accordance with an embodiment of the present disclosure. In an embodiment, the processor 116 includes a pre-processor 124 that pre-processes the raw input data 122. In an embodiment, pre-processor 124 applies domain-specific expertise related to the application (e.g., in radar imaging, pre-processing can include pulse compression and range alignment). In an embodiment, the pre-processed signal, which can be denoted as the observation or measurements, is supplied to an image estimator 120 to recover an image of the target or scene. In an embodiment, the recovered image can then be provided for storage in memory 114 and visualization on the computing device display 118. FIG. 1C is a block diagram of an exemplary image estimation process 126 (e.g., A-CG-GAN), which is described in more detail below (e.g., including elements 128-134), that can be used by image estimator 120 in accordance with an embodiment of the present disclosure.

Components of FIGS. 1A-1C can be implemented using hardware, software, and/or a combination of hardware and software. Components of FIGS. 1A-1C can be implemented using one device or a combination of devices. Components of FIGS. 1A-1C can be implemented onto host device(s) and/or as standalone special purposed devices.

In an embodiment, data acquisition system 102 is integrated onto a host platform, such as a ship or unmanned vehicle (e.g., an unmanned underwater vehicle). In a embodiment, data acquisition system 102 is a special purpose device integrated onto a host platform. In an embodiment, data acquisition system 102 uses elements of a host platform, and computing device 104 is implemented as a standalone special purpose device. In an embodiment, computing device 104 uses elements (e.g., memory 114, communications systems 112, and display 118) of a host platform, and processor 116 is implemented as a standalone special purpose device. In an embodiment, data acquisition system 102 uses a transmitter of a host platform as the source 106 and a receiving antenna of the host platform as the receiver 110. In an embodiment, data acquisition system 102 uses a single antenna of a host platform as the source 106 and the receiver 110.

In an embodiment, pre-processor 124 and image estimator 120 are implemented using a single special purpose device. In an embodiment, pre-processor 124 and image estimator 120 are implemented using separate single special purpose devices. Pre-processor 124 and image estimator 120 can be implemented using hardware, software, and/or a combination of hardware and software in accordance with embodiments of the present disclosure.

### 3. Preliminaries

We briefly introduce the CG prior and GANs as a prior. First, the forward measurement mapping considered:

$$Y = A c + v \qquad ( 1 )$$

where y∈ [symbol] ^{m} are the output observations (or measurements), A∈ [symbol] ^{m×n} is a sensing matrix, c∈ [symbol] ⁿ are the unknown input model parameters, and v∈ [symbol] ^{m} is additive white noise. In many applications of interest, m<<n, and A can be decomposed as A=ψΦ for Ψ∈ [symbol] ^{m×n} a measurement matrix and Φ∈ [symbol] ^{m×n} a change of basis dictionary. This formulation results from representing some original input model parameters, s, with respect to (w.r.t) Φ as s=Φc. In an embodiment, the linear inverse problem to (1) aims to recover c, or s, given y, Ψ, and Φ. For example, in tomography, Ψ may be a discrete Radon transform, Φ a sparsity inducing basis such as biorthogonal wavelets, and s is a vectorized image or scene of interest.

Note that, in an embodiment, in relation to the image estimation system of FIG. 1A-1C, the forward measurement mapping of equation (1) mathematically encapsulates the data acquisition system and pre-processing to produce observed data y. For example, in an embodiment, in radar imaging, s is the vectorized discretization of the target/scene reflectivity function, A involves the discrete Radon transformation, and v is thermal noise introduced by the receiver.

### 3.1. Compound Gaussian Prior

In an embodiment, a fruitful way to formulate inverse problems is by Bayesian estimation. In particular, the maximum a posteriori (MAP) estimate of c from (1) is:

$$\text{?} = arg \text{?} {‖ y - Ac ‖}_{2}^{2} - log ( \text{?} ( c ) ) \qquad ( 2 )$$

$$\text{?} \text{indicates text missing or illegible when filed}$$

where p_{c} is the assumed prior density of c. In an embodiment, the prior density of c, which incorporates domain-level knowledge into the inverse problem, is crucial to a successful MAP estimate. Coefficients of natural images exhibit self-similarity, heavy-tailed marginal distributions, and self-reinforcement among local coefficients. Such properties are not encompassed by the generalized Gaussian prior. Instead, CG densities, also known as Gaussian scale mixtures, better capture these statistical properties of natural images and images from other modalities such as radar. A useful formulation of the CG prior lies in modeling c as the Hadamard product:

$$c = z ⊙ u := {[ \text{?} ]}^{T} \qquad ( 3 )$$

$$\text{?} \text{indicates text missing or illegible when filed}$$

such that

$$u ∼ 𝒩 ( {μ}_{u} , {\sum }_{u}^{- 1} ) , z ∼ {p}_{z}$$

is sparse or heavy-tailed positive random vector, and u and z are independent. We call u and z the Gaussian variable and scale variable, respectively. By suitably defining the distribution of z, the CG prior subsumes many well-known distributions including the generalized Gaussian, Student's t, a-stable, and symmetrized Gamma distributions.

We note that decomposing c as in (3), the joint MAP estimate of z and u from (1) is:

$${z}^{*} , {u}^{*} = arg \text{?} \frac{1}{2} ‖ y - A ( z ⊙ u ) r {\vert \vert}_{2}^{2} - log ( \text{?} ( z ) ) + \frac{1}{2} {( u - \text{?} )}^{T} \text{?} ( u - \text{?} ) \qquad ( 4 )$$

$$\text{?} \text{indicates text missing or illegible when filed}$$

where the reconstructed inverse problem solution, c*, are then given by c*=c*⊙u*. That is, from (2) we set c=z⊙u, which, due to the independence of z and u, splits the prior term log(p_{c}(c)) into the sum of a prior term for z and a prior term for u.

### 3.1. GANs as a Prior

Let G: [symbol] ^{d}→ [symbol] ⁿ be the generative neural network (NN) from a GAN, which we assume has been adversarially trained against a discriminator NN D: [symbol] ⁿ→ [symbol] , to sample from some distribution (e.g., G produces “natural” images). Oftend<<n, implying that the generative DNN maps from a low-dimensional latent space to a high-dimensional space of interest. Given a low-dimensional latent distribution, pₓ, over [symbol] ^{d}, most commonly pₓ~ [symbol] (0, σ²I), we can generate a distribution from G as p_{G}~I for x~pₓ.

In an embodiment, a generative NN is incorporated as a prior by assuming that c from (1), satisfies c~p_{G}. That is, there exists a latent vector x~pₓ such that c=G(x). Therefore, in an embodiment, rather than optimize for the solution to the inverse problem directly, as in (2), we optimize over the latent space to find the best x* such that G(x*)≈c. On this front, consider the MAP estimate of x from (1), when c=G(x), given by:

$$\text{?} = arg \text{?} \frac{1}{2} {‖ y - AG ( x ) ‖}_{2}^{2} + \frac{1}{2 {σ}^{2}} {‖ x ‖}_{2}^{2} \text{?} \qquad ( 5 )$$

$$\text{?} \text{indicates text missing or illegible when filed}$$

Intuitively, if c is a “natural” image, and G samples from the distribution of “natural” images, then we can expect that c=G(x) for some x~pₓ.

### 4. ADMM with CG and GAN Priors (A-CG-GAN)

In an embodiment, to solve the linear inverse problem to (1) for the unknown vector c, we incorporate both the CG prior, as in (4), and GAN prior, as in (5), by setting the scale variable to lie within the range of a generative NN. Mathematically, we consider the following constrained optimization problem:

$$\text{?} = \text{?} F ( x , z , u , c ) \qquad ( 6 )$$

$$s . t . z = G ( x ) , c = z ⊙ u$$

$$where$$

$$F ( x , z , u , c ) := \frac{1}{2} {‖ y - Ac ‖}_{2}^{2} + μ ‖ z \text{?} + \text{?} ( x ) + \frac{λ}{2} {( u - \text{?} )}^{T} \text{?} ( u - \text{?} ) , \qquad ( 7 )$$

$$\text{?} \text{indicates text missing or illegible when filed}$$

G(⋅,Θ_{G}): [symbol] ^{d}→ [symbol] ⁿ is a generative NN, Rₓ: [symbol] ^{d}→ [symbol] is a convex regularization function, μ and λ are positive scaling parameters, and Dₓ, D_{z}, Dᵤ, and D_{c} are the convex domains of x, z, u, and c, respectively. We remark that the cost function, F, consists of a data fidelity term, a regularization term enforcing sparsity of z, an implicit regularization term on x, and a regularization term enforcing Gaussianity of u.

In an embodiment, we utilize ADMM to solve the constrained minimization problem of (6). For this, define the feasibility gap:

$${c}^{ξ ≡ ξ ( x , z , u , c ) := {[ {( z - G ( x ) )}^{T} {( c - z ⊙ u )}^{T} ]}^{T}} \qquad ( 8 )$$

and let ξₖ≡ξ(xₖ, zₖ, uₖ, cₖ). Additionally, define the augmented Lagrangian:

$${ℒ}_{ρ} ( x , z , u , c , ϕ ) := F ( x , z , u , c , ) + ( ϕ , ξ ) + \frac{p}{2} {‖ ξ ‖}_{2}^{2} \qquad ( 9 )$$

for a positive scalar p and a dual variable φ∈ [symbol] ²ⁿ. Therefore, the optimization problem of (6) is equivalent to:

$${arg min}_{( x , z , u , c ) ∈ {𝒟}_{x} \times {𝒟}_{z} \times {𝒟}_{u} \times {𝒟}_{c}} {arg max}_{ϕ} {ℒ}_{ρ} ( x , z , u , c , ϕ ) , \qquad ( 10 )$$

and the A-CG-GAN process iteratively solves (10) through an ADMM block coordinate descent as given in Image Estimation Process 1 and represented by the block flow diagram of FIG. 1C.

In an embodiment, to detail Image Estimation Process 1, let

$$ϕ = {[ {φ}_{1}^{T} {φ}_{2}^{T} ]}^{T}$$

and define:

$${𝒯}_{c} ≡ {𝒯}_{c} ( z , u , ϕ ) := {arg min}_{c} {ℒ}_{ρ} ( x , z , u , c , ϕ ) = {( {A}^{T} A + ρ I )}^{- 1} ( {A}^{T} y + ρ z ⊙ u - {φ}_{2} ) \qquad ( 11 )$$

$${𝒯}_{u} ≡ {𝒯}_{u} ( z , c , ϕ ) := {arg min}_{u} {ℒ}_{ρ} ( x , z , u , c , ϕ ) = {( ρ {Diag ( z )}^{2} + λ {\sum }_{u} )}^{- 1} ( λ {\sum }_{u} {μ}_{u} + z ⊙ ( ρ c + {φ}_{2} ) ) . \qquad ( 12 )$$

In an embodiment, on iteration k of A-CG-GAN, we minimize (9) with respect to u and c by applying Tᵤ and T_{c} in lines 5 and 6 of Image Estimation Process 1, respectively. Note that the singular value decomposition

$$( SVD ) {\sum }_{u} = {V}_{u} {S}_{u} {V}_{u}^{T} and A = {U}_{A} {S}_{A} {V}_{A}^{T}$$

can be used to alternative express Tᵤ and T_{c} as

$${𝒯}_{c} ≡ {𝒯}_{c} ( z , u , ϕ ) := {arg min}_{c} {ℒ}_{ρ} ( x , z , u , c , ϕ ) = {{V}_{A} ( {S}_{A}^{T} {S}_{A} + ρ I )}^{- 1} {V}_{A}^{T} ( {A}^{T} y + ρ z ⊙ u - {φ}_{2} ) \qquad ( 13 )$$

$${𝒯}_{u} ≡ {𝒯}_{u} ( z , c , ϕ ) := {arg min}_{u} {ℒ}_{ρ} ( x , z , u , c , ϕ ) = {{V}_{u} ( ρ {Diag ( z )}^{2} + {S}_{u} )}^{- 1} [ {S}_{u} {V}_{u}^{T} {μ}_{u} + {V}_{u}^{T} ( z ⊙ ( ρ c + {φ}_{2} ) ) ] , \qquad ( 14 )$$

which avoids the inversion of the full matrices ρDiag(z)²+Σᵤ and A^{T}A+ρI, respectively.

As the feasibility terms

$$〈 ϕ , ξ 〉 + \frac{ρ}{2} {‖ ξ ‖}_{2}^{2} in ( 9 )$$

are convex with respect to z, we minimize L_{ρ} in (9) with respect to z using a standard fast ISTA (FISTA) technique. We will write:

$${𝒯}_{z}^{( J )} ≡ {𝒯}_{z}^{( J )} ( x , z , u , c , ϕ ) = J FISTA steps on {ℒ}_{ρ} w . r . t z . \qquad ( 15 )$$

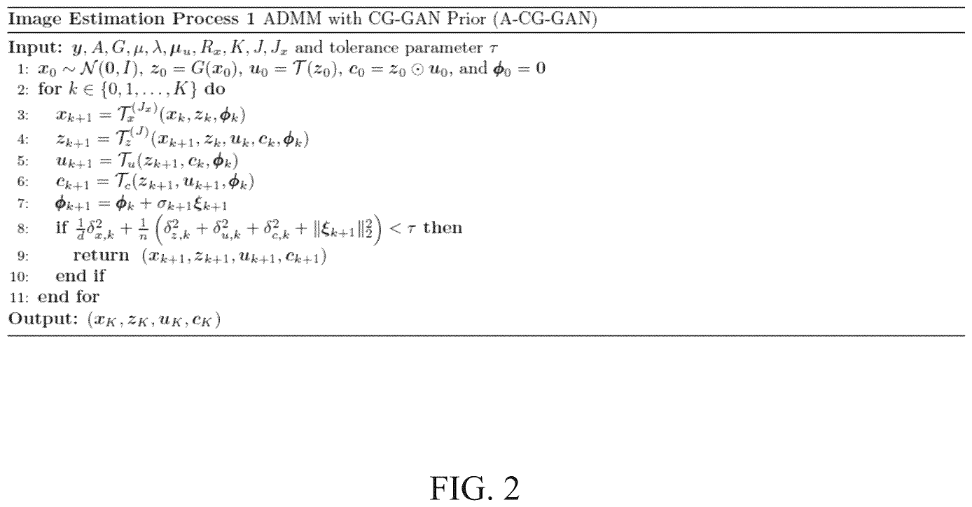

FIG. 2 is a diagram showing exemplary pseudocode for Image Estimation Process 1 in accordance with an embodiment of the present disclosure.

In an embodiment, to further detail the z update, let L be the differential portion of (9), i.e., \tilde{L} is (9) without μ∥z∥ₗ, and define the Soft Thresholding function SF: [symbol] ⁿ→ [symbol] ⁿ as

$$SF ( z ; α ) = {[ max \{ \vert {z}_{i} \vert - α , 0 \} sign ( {z}_{i} ) ]}_{i = 1}^{n} . \qquad ( 16 )$$

Next, in an embodiment, define the z ISTA step function on (9), denoted by ISTA_{L}: [symbol] ^{d}× [symbol] ⁿ× [symbol] ⁿ× [symbol] ⁿ× [symbol] ⁿ× [symbol] ⁿ→ [symbol] ⁿ, as:

$${ISTA}_{ℒ} ( x , z , u , c , {φ}_{1} , {φ}_{2} ; μ , ρ , {Θ}_{G} ) := SF ( z - {η}_{z} {∇}_{z} \tilde{ℒ} ( x , c , u , c , {φ}_{1} , {φ}_{2} ; ρ , {Θ}_{G} ) ; {μη}_{z} ) \qquad ( 17 )$$

where the gradient of \tilde{L} with respect to z is:

$${∇}_{z} \tilde{ℒ} = ρ ( z - G ( x ; {Θ}_{G} ) + u ⊙ ( z ⊙ - c ) ) + {φ}_{1} - u ⊙ {φ}_{2} \qquad ( 18 )$$

and the step size

$${η}_{z} = {{ρ}^{- 1} ( 1 + {max}_{1 \leq i \leq n} {u}_{i}^{2} )}^{- 1}$$

is the reciprocal maximum eigenvalue of the Hessian of \tilde{L} with respect to z. Now, define the z FISTA step function on (9), denoted by FISTA_{L}: [symbol] ^{d}× [symbol] ⁿ× [symbol] ⁿ× [symbol] ⁿ× [symbol] ⁿ× [symbol] ⁿ× [symbol] ⁿ× [symbol] → [symbol] ⁿ,

$${FISTA}_{ℒ} ( x , z , \overline{z} , u , c , {φ}_{1} , {φ}_{2} , t ; μ , ρ , {Θ}_{G} ) := {ISTA}_{ℒ} ( x , z + t ( z - \overline{z} ) , u , c , {φ}_{1} , {φ}_{2} ; μ , ρ , {Θ}_{G} ) \qquad ( 19 )$$

In an embodiment, The jth estimate of z on iteration k+1 of A-CG-GAN, denoted by

$${z}_{k + 1}^{( j )}$$

is given by:

$${z}_{k + 1}^{( j )} = {FISTA}_{ℒ} ( {x}_{k + 1} , {z}_{k + 1}^{( j - 1 )} , {z}_{k + 1}^{( j - 2 )} , {u}_{k} , {c}_{k} , {φ}_{1 , k} , {φ}_{2 , k} , {t}_{j} ; μ , ρ , {Θ}_{G} ) \qquad ( 20 )$$

where

$${z}_{k + 1}^{( 0 )} = {z}_{k + 1}^{( - 1 )} = {z}_{k} = {z}_{k}^{( {J}_{z} )} and {t}_{j} = {s}_{j}^{( - 1 )} ( {s}_{j - 1} - 1 ) for {s}_{0} = 1 and$$

$${s}_{j} = \frac{1}{2} + \frac{1}{2} \sqrt{1 + 4 {s}_{j - 1}^{2}}$$

is chosen. Finally, in an embodiment as given in line 4 of Image Estimation Process 1, we denote all J FISTA steps on (9) with respect to z by

$${T}_{z}^{( J )}$$

Next, in an embodiment, for the update of x, which can require optimizing over the non-convex generative NN G, we use adaptive moment estimation (Adam), a gradient descent (GD)-based optimizer, with a step size of 10⁻². In an embodiment, the gradient, ∇ₓL_{ρ}, for each GD step, is calculated using backpropagation and automatic differentiation in TensorFlow. In an embodiment, we will write:

$${𝒯}_{x}^{( {J}_{x} )} ≡ {𝒯}_{z}^{( {J}_{z} )} ( x , z , ϕ ) = {J}_{x} GD steps on {ℒ}_{p} \qquad ( 21 )$$

with respect to x.

In an embodiment, as this update can require Rr to be differentiable, we instead use Jₓ ISTA or proximal gradient descent (PGD) steps to minimize L_{ρ} with respect to x when Rₓ is non-smooth and also denote these Jₓ steps as

$${T}_{x}^{( {J}_{x} )}$$

for simplicity.

FIG. 1C is a block diagram of an exemplary image estimation process 126 (e.g., A-CG-GAN). FIG. 1C will now be described in more detail. In an embodiment, the A-CG-GAN process of FIG. 1C includes six initialization blocks 128 (X₀, Z₀, U₀, C₀,

$${φ}_{0}^{( 2 )} , and {φ}_{0}^{( 1 )} ,$$

K iterations 130, where each iteration k includes six update blocks 132

$$( {X}_{k} , {Z}_{k} , {U}_{k} , {C}_{k} , {φ}_{k}^{( 2 )} , and {φ}_{k}^{( 1 )}$$

and finally an output block O 134.

In an embodiment, each Xₖ and Zₖ correspond to the x and z estimates on iteration k of Image Estimation Process 1, respectively. Similarly, in an embodiment, each Uₖ and Cₖ block corresponds respectively to the u and c estimates on iteration k of Image Estimation Process 1, while blocks

$${φ}_{k}^{( 2 )} , and {φ}_{k}^{{( 1 )}_{k}}$$

correspond to the dual-variable estimate on iteration k in Image Estimation Process 1. In FIG. 1C, arrows with a solid line mark connections from previous iterations, and arrows with dotted lines mark connections within an iteration.

In an embodiment, the dual variable, φ, is updated via a single gradient ascent step on L_{ρ} as in ADMM. That is:

$$ϕ ← ϕ + σ {∇}_{ϕ} {ℒ}_{p} = ϕ + σ ζ \qquad ( 22 )$$

where σ is a real-value step size parameter.

As specified in Image Estimation Process 1, the initial estimates can given by x₀~ [symbol] (0, I), z₀=G(x₀), u₀=T(z₀), and c₀=z₀⊙u₀ where, for A_{z}=ADiag(z),

$$𝒯 ( z ) := \text{?} \tilde{F} ( z , u ) = \text{?} + λ \text{?} ( λ \text{?} + \text{?} y ) \qquad ( 23 )$$

$$for F ( z , u ) = ( {A}_{z}^{T} {A}_{z} + λ {\sum }_{u} ( u - {μ}_{u} ) ) .$$

$$\text{?} \text{indicates text missing or illegible when filed}$$

Lastly, in an embodiment, define δ_{x,k}=∥xₖ₊₁−xₖ∥₂ and similarly define δ_{z,k}, δ_{u,k}, and δ_{c,k}. In an embodiment, convergence of A-CG-GAN is determined by:

$$\text{?} + \text{?} ( \text{?} + \text{?} + \text{?} + {‖ \text{?} ‖}_{2}^{2} ) < \text{?} \qquad ( 24 )$$

$$\text{?} \text{indicates text missing or illegible when filed}$$

for a tolerance parameter τ. In an embodiment, this stopping condition ensures that the mean squared error in both the feasibility gap and the change in each of the four primal variables is sufficiently small.

### 5. Empirical Results

In an embodiment, we examine A-CG-GAN, from Image Estimation Process 1, for two linear inverse problems in imaging, namely compressive sensing (CS) (where Ψ∈ [symbol] _{m×n} has entries sampled [symbol] (0, 1/m)) and X-ray computed tomography (CT) (where Ψ corresponds to a Radon transform at a number of uniformly spaced angles). Comparisons are made against four methods that similarly consider a GAN-prior in solving inverse problems, which we denote by Bora, Dhar, Shah, and Latorre.

For data, we use 32×32 CIFAR10 images and CalTech101 images downsampled to size 64×64 (and 32×32). With the CIFAR10 and 64×64 CalTech101 datasets, we set aside 100 images to serve as the testing data and we train a DCGAN on the remaining images, which are augmented using rotation and reflection. We use G:: [symbol] ^{d}→ [symbol] ⁿ, with d=100, to denote the DCGAN generator.

For training G̅, which has a tanh output activation function, we scale and shift the training images onto the range [−1, 1] by replacing training image I by (2/Iₘₐₓ)(I−1), where Iₘₐₓ is the max pixel value of I. For testing—i.e., solving the inverse problem to (1)—we scale the testing images onto the range [0, 1] by replacing test image/by I/Iₘₐₓ. A measurement matrix Ψ is applied to each test image, after which white noise is added, producing noisy measurements, y, at a specified signal-to-noise ratio (SNR). Additionally, for testing, we scale and shift the outputs from G̅ onto the range [0, 1] by considering the generator

$$\tilde{G} ( x ) = \frac{\tilde{G} ( x ) + 1}{2} .$$

Note that scaling to the range [0, 1] for testing is conducted so that we can use the structural similarity index measure (SSIM), which requires input images with positive pixel values, to assess the reconstruction performance.

In an embodiment, for the A-CG-GAN process, we will take the generative NN G(x)=\tilde{Φ}G(x), where \tilde{Φ}∈ [symbol] ^{n×n} is a sparsity change-of-basis matrix. We apply the change-of-basis matrix since we desire for the generative NN to produce sparse scale variables rather than the image directly. Further, we set μᵤ=0, Σᵤ=I, Rₓ≡0, τ=10⁻⁶, K=1000, and Jₓ=J=10 for all testing of A-CG-GAN. Instead, for each comparison method, we use G(x)=\tilde{G}(x) as the generative NN prior and a grid search is performed to find the best hyperparameters for each of the four comparison methods. Finally, for each comparison method, random restarts were implemented as specified in each work respectively. We remark that using the same underlying image-generating NN provides fairness in testing the inverse problems comparisons since we guarantee the generative NN used in our method and each comparison method has the same training and quality.

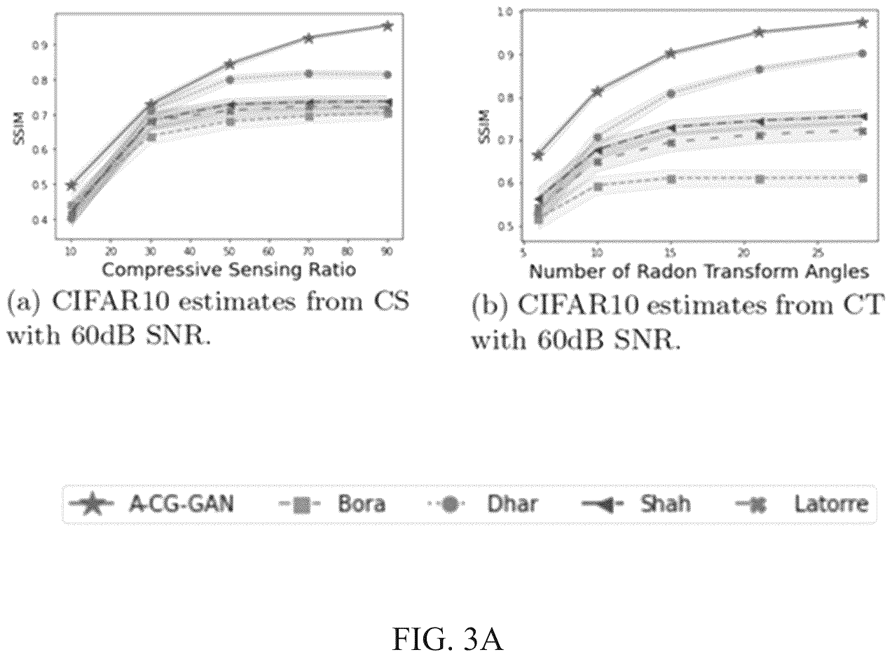

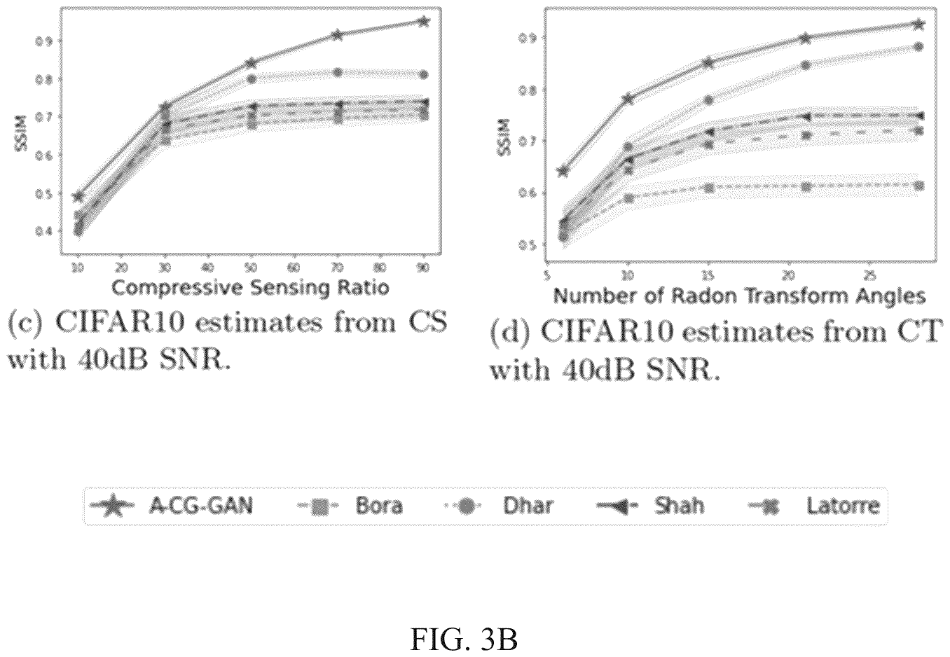

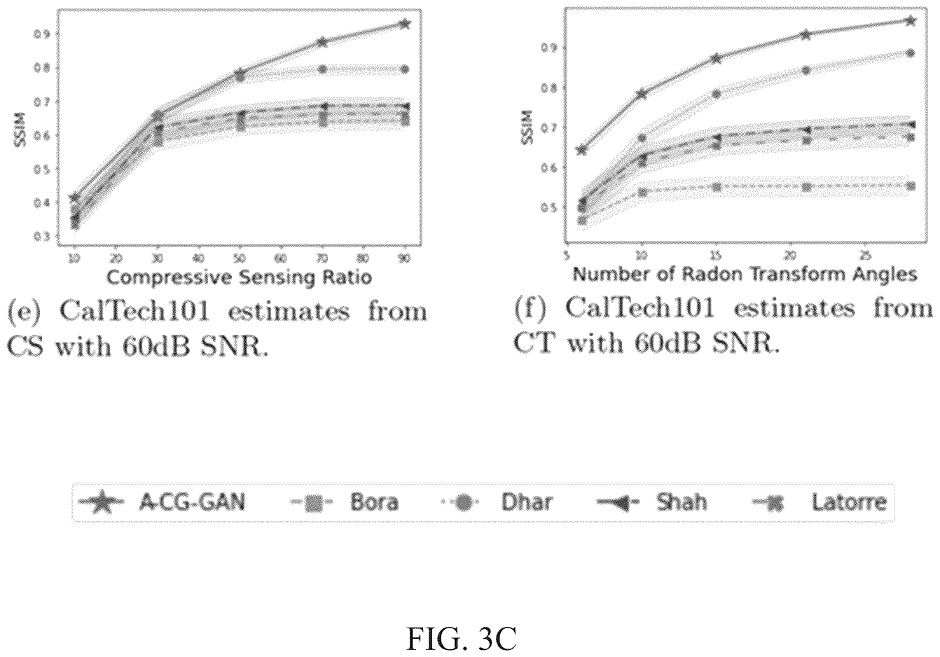

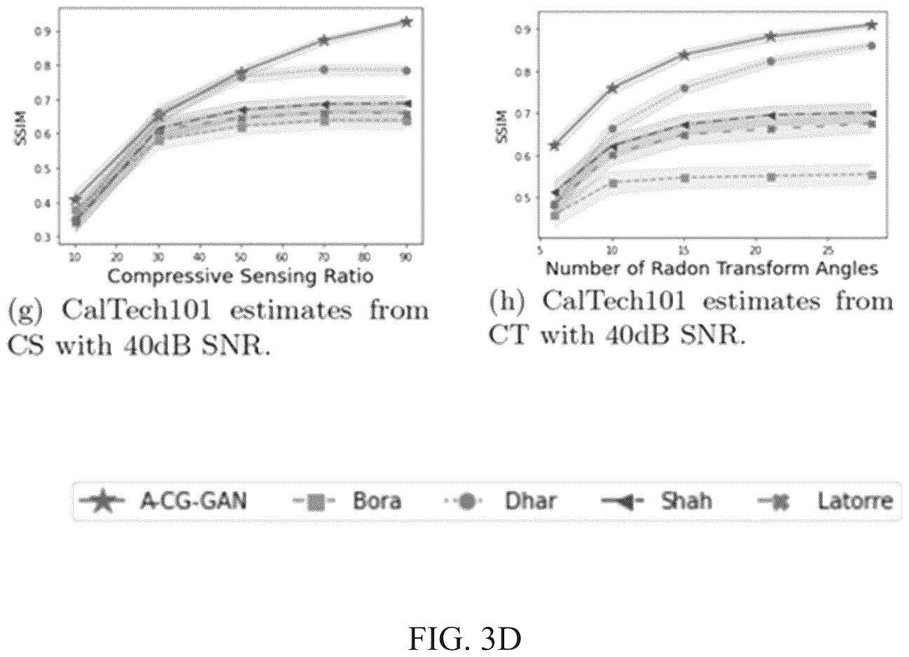

FIGS. 3A-3D are plots showing average Structural Similarity Index measure (SSIM) in accordance with an embodiment of the present disclosure. In an embodiment, larger values denote a reconstruction more closely matching the original image—over the reconstructions of one hundred 32×32 images from A-CG-GAN and each of the four comparison methods. Each plot in FIGS. 3A-3D gives both the average SSIM and 99% confidence interval—visualized by the background shading—as the dimension of y is varied in both CS and CT problems. The underlying DCGAN generator, G̅, used for each of these inverse problems, has been trained on 50000 CIFAR10 images. Through a grid search, we set the hyperparameters of A-CG-GAN to be (λ, μ, ρ)=(0.1, 10⁻³, 1) and (λ, μ, ρ)=(1, 10⁻², 1) for CT reconstructions from 60 dB and 40 dB, respectively. Further, we set (λ, μ, ρ)=(10⁻⁶, 10⁻⁶, 10⁻⁴) as the hyperparameters of A-CG-GAN for CS reconstructions. Additionally, we use \tilde{Φ}=Φ=discrete cosine transformation and \tilde{Φ}=Φ=I for CS and CT problems, respectively.

In FIGS. 3A and 3B, CIFAR10 images are reconstructed from CS and CT measurements with an SNR of 60 dB and 40 dB, respectively. In FIGS. 3C and 3D, we show the generalizability of our method by reconstructing CalTech101 images, that have been downsampled to size 32×32, while using the same CIFAR10 trained G.

We observe, from FIGS. 3A-3D, that A-CG-GAN outperforms, or performs comparably to, each of the other four methods in all scenarios. In particular, we highlight that the performance of A-CG-GAN does not saturate as the dimension of y increases—i.e., the sampling from the forward measurement mapping increases—while the performance of the comparisons in general does. Additionally, A-CG-GAN is able to generalize well to image distributions outside of the GAN training distribution as shown in FIGS. 3C and 3D.

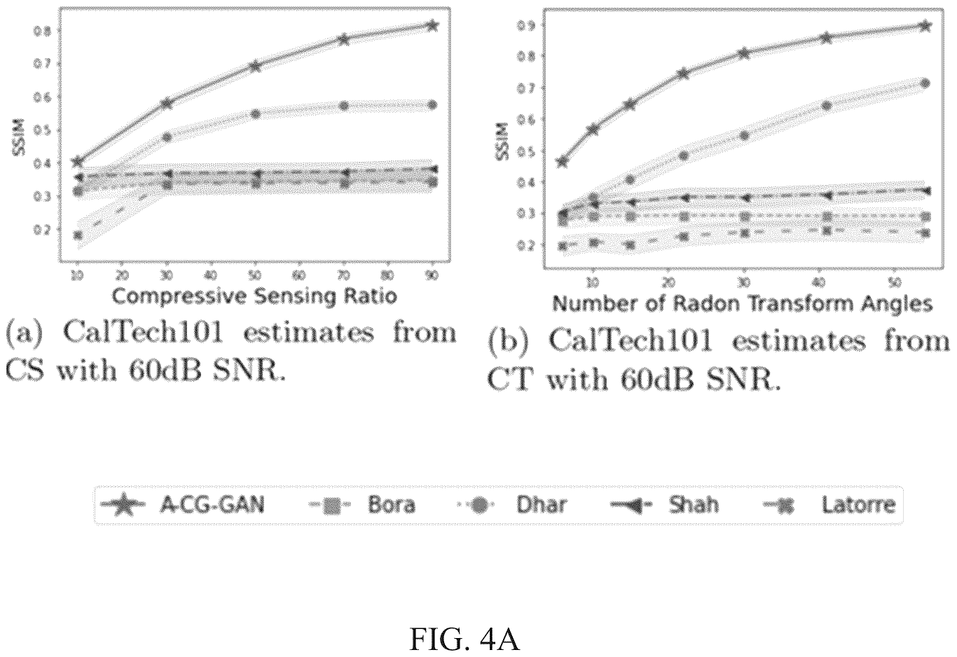

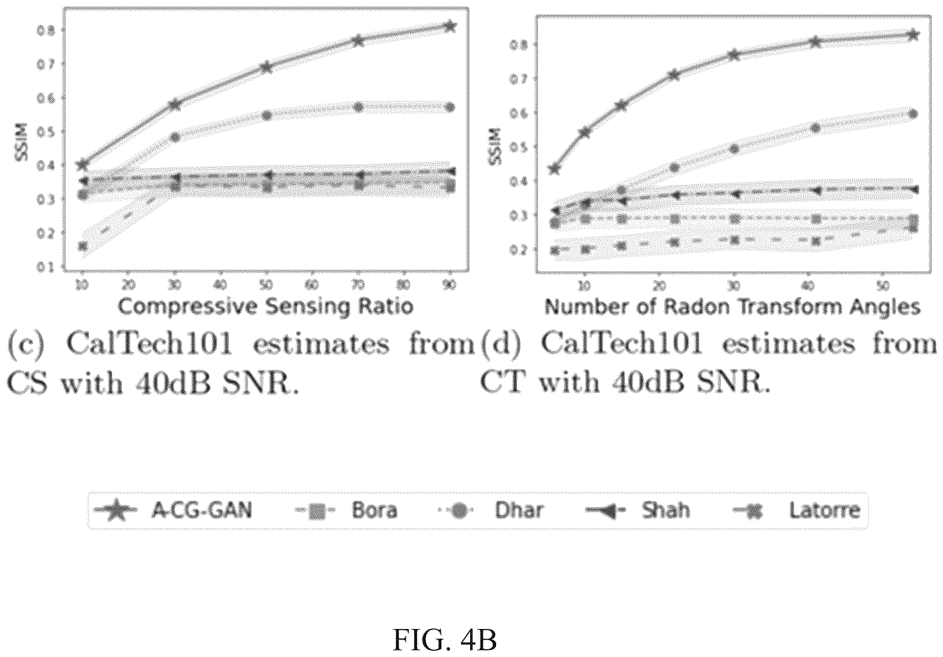

FIGS. 4A and 4B are plots showing the average SSIM over the reconstructions of one hundred 64×64 images from A-CG-GAN and each of the four comparison methods in accordance with an embodiment of the present disclosure. Each plot in FIGS. 4A and 4B gives both the average SSIM and 99% confidence interval-visualized by the background shading—as the amount of sampling from the forward measurement mapping—i.e., the dimension of y—is varied in both CS and CT problems. The underlying DCGAN generator, G̅, used for each of these inverse problems has been trained on a minimal dataset of roughly 9000 CalTech101 images of size 64×64. Empirically, we choose (λ, μ, ρ)=0.25×(10⁻⁶, 10⁻⁶, 10⁻⁴) in A-CG-GAN for CS reconstructions, (λ, μ, ρ)=(10, 0.1, 10) for 40 dB CT reconstructions, and otherwise use the same setup as in the 32×32 image reconstruction cases.

We observe from FIGS. 4A and 4B, that A-CG-GAN outperforms each of the four methods in all scenarios. We highlight, in particular, that while a sub-optimal generator, due to a small training dataset, severely diminished the performance of FIGS. 3A-3D: Average SSIM, with 99% confidence intervals, for five reconstruction methods, using a generative adversarial network prior, which reconstructed one hundred 32×32 test images (either CIFAR10 or CalTech101 downsampled to 32×32 size). The average SSIM is presented as we either vary the compressive sensing ratio min or the number of angles in the Radon transform. The A-CG-GAN method outperforms, or performs comparably to, the other methods in all scenarios. A-CG-GAN still provides relatively high-quality reconstructed images as measured by SSIM. This is perhaps anticipated given the dual prior basis our method implements, which alleviates a complete dependence on the generative NN prior as in Bora, Shah, and Latorre. Additionally, we again observe, from FIGS. 4A and 4B, that A-CG-GAN eliminates the performance saturation with increasing sampling from the forward measurement mapping.

### 6. Exemplary Methods

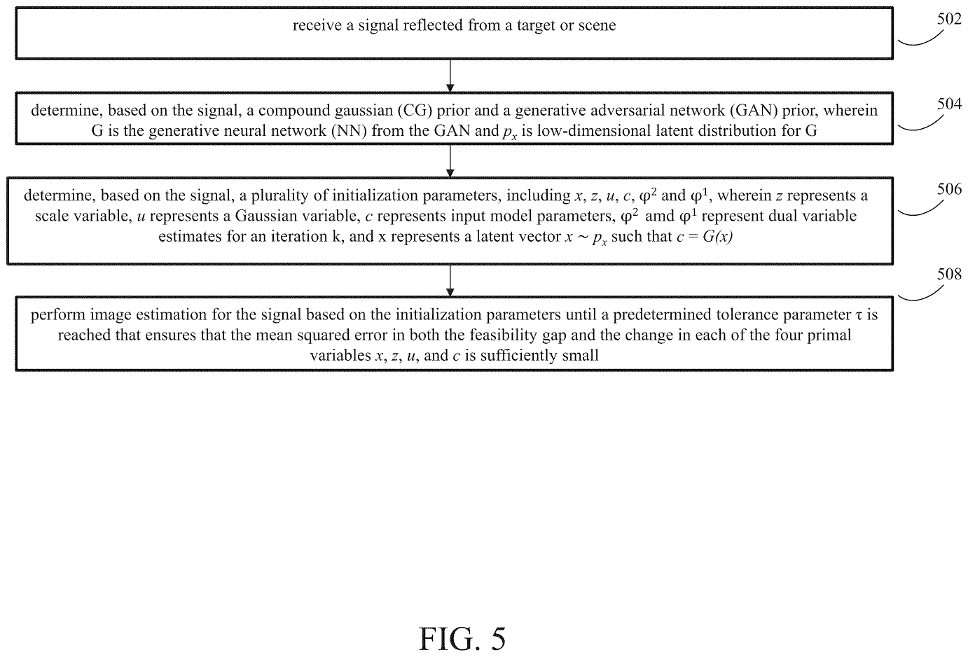

FIG. 5 is a flowchart of an exemplary method in accordance with an embodiment of the present disclosure. In step 502, a signal reflected from a target or scene is received. For example, in an embodiment, receiver 110 of data acquisition system 102 receives a signal reflected from target 108 after source 106 sent a signal towards target 108.

In step 504, a determination is made based on the signal, a compound gaussian (CG) prior and a generative adversarial network (GAN) prior, wherein G is the generative neural network (NN) from the GAN and pₓ is low-dimensional latent distribution for G. For example, in an embodiment, receiver 110 sends the signal to computing device 104 and processor 116 makes the determination in step 104.

In step 506, a determination is made based on the signal, a plurality of initialization parameters, including x, z, u, c, φ2 and φ1, wherein z represents a scale variable, u represents a Gaussian variable, c represents input model parameters, φ2 and φ1 represent dual variable estimates for an iteration k, and x represents a latent vector x~pₓ such that c=G(x). For example, in an embodiment, processor 116 makes the determination in step 506.

In step 508, image estimation is performed for the signal based on the initialization parameters until a predetermined tolerance parameter t is reached that ensures that the mean squared error in both the feasibility gap and the change in each of the four primal variables x, z, u, and c is sufficiently small. For example, in an embodiment, image estimator 120 of processor 116 performs the image estimation in step 508.

### 7. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

1. An image estimation system, comprising:
a data acquisition system, comprising:
a source configured to transmit a waveform, and
a receiver configured to receive a signal from a target, wherein the signal is a reflected version of the waveform; and
a computing device, comprising:
a processor, wherein the processor is configured to perform operations comprising:
determining, based on the signal, a compound gaussian (CG) prior and a generative adversarial network (GAN) prior, wherein G is the generative neural network (NN) from the GAN and pₓ is low-dimensional latent distribution for G,
determining, based on the CG prior, the GAN prior, the signal, a plurality of initialization parameters, including x, z, u, c, φ² and φ¹, wherein z represents a scale variable, u represents a Gaussian variable, c represents input model parameters, φ² and φ¹ represent dual variable estimates for an iteration k, and x represents a latent vector x~pₓ such that c=G(x), and
performing image estimation for the signal based on the initialization parameters until a predetermined tolerance parameter t is reached that ensures that a mean squared error in both a feasibility gap and a change in each of the variables x, z, u, and c is sufficiently small.

2. The image estimation system of claim 1, further comprising:
a host platform comprising:
the data acquisition system,
the computing device, and
a radar, wherein the radar comprises the receiver.

3. The image estimation system of claim 2, wherein the host platform is a ship.

4. The image estimation system of claim 2, wherein the host platform is an unmanned underwater vehicle (UUV).

5. The image estimation system of claim 1, wherein the signal is represented by y=Ac+v, wherein y∈ [symbol] ^{m} represents output observations (or measurements), A∈ [symbol] ^{m×n} is a sensing matrix, c∈ [symbol] ⁿ are the unknown input model parameters, and v∈ [symbol] ^{m} is additive white noise.

6. The image estimation system of 5, wherein to solve a linear inverse problem for c, the computing device is further configured to perform operations comprising:
setting z to lie within a range of G.

7. The image estimation system of claim 1, wherein a dual variable φ, corresponding to φ² and φ¹, is updated via a single gradient ascent step.

8. The image estimation system of claim 1, wherein initial estimates for the plurality of initialization parameters can be represented by x0~ [symbol] (0, I), z0=G(x), u0=T(z0), and c0=z0⊙u0, wherein pₓ~ [symbol] (0, σ²I) and pG~I for x~px, wherein σ is a real-value step size parameter, and wherein
$$ϕ = {[ \begin{matrix}{φ}_{1}^{T} & {φ}_{2}^{T}\end{matrix} ]}^{T} .$$

9. A vehicle, the vehicle comprising:
a data acquisition system, comprising:
a radar configured to:
transmit a waveform towards a target, and
receive a signal from the target, wherein the signal is a reflected version of the waveform; and
a computing device, comprising:
a memory,
a display, and
a processor, wherein the processor is configured to perform operations comprising:
determining, based on the signal, a compound gaussian (CG) prior and a generative adversarial network (GAN) prior, wherein G is the generative neural network (NN) from the GAN and pₓ is low-dimensional latent distribution for G,
determining, based on the CG prior, the GAN prior, the signal, a plurality of initialization parameters, including x, z, u, c, φ² and φ¹, wherein z represents a scale variable, u represents a Gaussian variable, c represents input model parameters, φ² and φ¹ represent dual variable estimates for an iteration k, and x represents a latent vector x~pₓ such that c=G(x),
performing image estimation for the signal based on the initialization parameters until a predetermined tolerance parameter τ is reached that ensures that a mean squared error in both a feasibility gap and a change in each of the variables x, z, u, and c is sufficiently small, and
sending output resulting from the image estimation to the display.

10. The vehicle of claim 9, wherein the vehicle is a ship.

11. The vehicle of claim 9, wherein the vehicle is an unmanned underwater vehicle (UUV).

12. The vehicle of claim 9, wherein the signal is represented by y=Ac+v, wherein y∈ [symbol] ^{m} represents output observations (or measurements), A∈ [symbol] ^{m×n} is a sensing matrix, c∈ [symbol] ⁿ are the unknown input model parameters, and v∈ [symbol] ^{m} is additive white noise.

13. The vehicle of claim 12, wherein to solve a linear inverse problem for c, the computing device is further configured to perform operations comprising:
setting z to lie within a range of G.

14. The vehicle of claim 9, wherein a dual variable φ, corresponding to φ² and φ¹, is updated via a single gradient ascent step.

15. The vehicle of claim 9, wherein initial estimates for the plurality of initialization parameters can be represented by x0~ [symbol] (0, I), z0=G(x), u0=T(z0), and c0=z0⊙u0, wherein px~ [symbol] (0, σ²I) and pG~I for x~px, wherein σ is a real-value step size parameter, and wherein
$$ϕ = {[ \begin{matrix}{φ}_{1}^{T} & {φ}_{2}^{T}\end{matrix} ]}^{T} .$$

16. A method, comprising:
transmitting, using a radar device, a waveform towards a target;
receiving, using the radar device, a signal from the target, wherein the signal is a reflected version of the waveform;
determining, based on the signal, a compound gaussian (CG) prior and a generative adversarial network (GAN) prior, wherein G is the generative neural network (NN) from the GAN and pₓ is low-dimensional latent distribution for G;
determining, based on the CG prior, the GAN prior, the signal, a plurality of initialization parameters, including x, z, u, c, φ² and φ¹, wherein z represents a scale variable, u represents a Gaussian variable, c represents input model parameters, φ² and φ¹ represent dual variable estimates for an iteration k, and x represents a latent vector x~pₓ such that c=G(x); and
performing image estimation for the signal based on the initialization parameters until a predetermined tolerance parameter t is reached that ensures that a mean squared error in both a feasibility gap and a change in each of the variables x, z, u, and c is sufficiently small.

17. The method of claim 16, wherein the signal is represented by y=Ac+v, wherein y∈ [symbol] ^{m} represents output observations (or measurements), A∈ [symbol] ^{m×n} is a sensing matrix, c∈ [symbol] ⁿ are the unknown input model parameters, and v∈ [symbol] ^{m} is additive white noise.

18. The method of claim 17, wherein to solve a linear inverse problem for c, the computing device is further configured to perform operations comprising:
setting z to lie within a range of G.

19. The method of claim 16, wherein a dual variable e, corresponding to φ² and φ¹, is updated via a single gradient ascent step.

20. The method of claim 16, wherein initial estimates for the plurality of initialization parameters can be represented by x0~ [symbol] (0, I), z0=G(x), u0=T(z0), and c0=z0⊙u0, wherein px~ [symbol] (0, σ²I) and pG~I for x~px, wherein σ is a real-value step size parameter, and wherein
$$ϕ = {[ \begin{matrix}{φ}_{1}^{T} & {φ}_{2}^{T}\end{matrix} ]}^{T} .$$
